(19) United States
(12) Patent Application Publication
(10) Pub. No.: US 2026/0072313 A1
(43) Pub. Date: Mar. 12, 2026

(54) LIQUID CRYSTAL DISPLAY DEVICE

(71) Applicant: Sharp Display Technology Corporation, Kameyama City (JP)

(72) Inventors: Sumire NAGOYA, Kameyama City (JP); Masanobu MIZUSAKI, Kameyama City (JP); Kazuhito MATSUMOTO, Kameyama City (JP); Shinpei HIGASHIDA, Kameyama City (JP); Noboru MATSUDA, Kameyama City (JP); Shinji SHIMADA, Kameyama City (JP)

(21) Appl. No.: 19/325,963

(22) Filed: Sep. 11, 2025

(30) Foreign Application Priority Data
Sep. 12, 2024 (JP) 2024-158235

(51) Int. Cl. G02F 1/1337; G02F 1/1343

(52) U.S. Cl. CPC G02F 1/133738; G02F 1/133788; G02F 1/134372

(57) ABSTRACT

Provided is a liquid crystal display device that includes, in order: a first substrate including gate lines extending in a first direction, source lines extending in a second direction; a first alignment film; and a liquid crystal layer containing liquid crystal molecules. The second electrode has an elongated opening. The first substrate includes a step portion extending in a third direction. An angle α formed in a plan view between the third direction and an alignment direction of liquid crystal molecules located near the first alignment film and within a central portion of the opening with no voltage applied, is between 0° and 90°, exclusive. A parameter P is 0.77 or less, as calculated using the angle α, a taper angle β of the step portion, and a contact angle θa of the first alignment film with respect to pure water, from the following Equation (1):

$$P = ( {θ}_{a} / 90 ° ) \times \{ 1 + 2 sin ( α ) \times cos ( α ) \} \times sin ( β ) \qquad ( 1 )$$

### CROSS-REFERENCE TO RELATED APPLICATIONS

The present application claims priority under 35 U.S.C. § 119 to Japanese Patent Application No. 2024-158235 filed on Sep. 12, 2024, the contents of which are incorporated herein by reference in their entirety.

### BACKGROUND OF THE INVENTION

### Field of the Invention

The following disclosure relates to liquid crystal display devices.

### Description of Related Art

JP 2007-248557 A discloses a technique related to liquid crystal display devices, specifically a transverse electric field liquid crystal display apparatus. The liquid crystal display apparatus includes a first substrate; a second substrate facing the first substrate; a liquid crystal layer disposed between said first substrate and said second substrate; and a pixel electrode and common electrode that are formed on said first substrate on the surface thereof facing said second substrate and that produce an electric field parallel to said first substrate. The shapes of said pixel electrode and said common electrode are established so that the pixel region between said pixel electrode and said common electrode has formed therein a principal portion whose electric field direction is orthogonal to the initial alignment direction of the liquid crystal molecules, and a specific portion that is smaller than the principal portion and whose electric field is not orthogonal.

### SUMMARY

The present disclosure aims to provide a liquid crystal display device capable of reducing or preventing a decrease in contrast ratio.

(1) One embodiment of the present invention is directed to a liquid crystal display device including, in order: a first substrate including gate lines, source lines, nonlinear elements arranged corresponding to intersections of the gate lines and the source lines, a first electrode, and a second electrode; a first alignment film; a liquid crystal layer containing liquid crystal molecules; and a second substrate, the gate lines extending in a first direction, the source lines extending in a second direction which intersects the first direction, the first electrode and the second electrode at least partially facing each other across an insulating layer, one electrode of the first electrode and the second electrode being connected to a source line corresponding to the one electrode via a nonlinear element corresponding to the one electrode among the nonlinear elements, the second electrode being provided with an elongated opening, the first substrate including a step portion extending in a third direction on a surface closer to the first alignment film, an angle α, defined in a plan view as an angle between the third direction and an alignment direction of liquid crystal molecules located near the first alignment film and within a central portion of the opening with no voltage applied, being greater than 0° and less than 90°, a parameter P being 0.77 or less, as calculated based on the angle α, a taper angle β of the step portion, and a contact angle θa of the first alignment film with respect to pure water, in accordance with the following Equation (1):

$$P = ( {θ}_{a} / 90 ° ) \times \{ 1 + 2 sin ( α ) \times cos ( α ) \} \times sin ( β ) \qquad ( 1 )$$

wherein when the taper angle β exceeds 90°, β in Equation (1) is set to 90°.

(2) In an embodiment of the present invention, the liquid crystal display device includes the structure (1), and the parameter P represented by Equation (1) is 0.074 or more.

(3) In an embodiment of the present invention, the liquid crystal display device includes the structure (1) or (2), and among the liquid crystal molecules, liquid crystal molecules located near the first alignment film are at a pre-tilt angle of 0° or greater and 3° or less.

(4) In an embodiment of the present invention, the liquid crystal display device includes the structure (1), (2), or (3), and the taper angle β of the step portion is 60° or greater and 90° or less.

(5) In an embodiment of the present invention, the liquid crystal display device includes the structure (1), (2), (3), or (4), and in a plan view, the alignment direction of the liquid crystal molecules located near the first alignment film and within the central portion of the opening with no voltage applied is parallel or perpendicular to the first direction.

(6) In an embodiment of the present invention, the liquid crystal display device includes the structure (1), (2), (3), (4), or (5), the liquid crystal molecules have a positive anisotropy of dielectric constant, in a plan view, the alignment direction of the liquid crystal molecules located near the first alignment film and within the central portion of the opening with no voltage applied is perpendicular to the first direction, and the angle α is 3° or greater and 45° or less.

(7) In an embodiment of the present invention, the liquid crystal display device includes the structure (1), (2), (3), (4), or (5), the liquid crystal molecules have a negative anisotropy of dielectric constant, in a plan view, the alignment direction of the liquid crystal molecules located near the first alignment film and within the central portion of the opening with no voltage applied is parallel to the first direction, and the angle α is 45° or greater and 87° or less.

(8) In an embodiment of the present invention, the liquid crystal display device includes the structure (1), (2), (3), (4), (5), (6), or (7), and the step portion includes an end of the opening of the second electrode.

(9) In an embodiment of the present invention, the liquid crystal display device includes the structure (1), (2), (3), (4), (5), (6), or (7), the first substrate further includes a light-shielding film arranged adjacent to a surface of the second electrode facing the liquid crystal layer, and the step portion includes an end of the light-shielding film.

(10) In an embodiment of the present invention, the liquid crystal display device includes the structure (9), the step portion further includes an end of the opening of the second electrode.

(11) In an embodiment of the present invention, the liquid crystal display device includes the structure (9) or (10), and the light-shielding film is a metal film or a laminate including a metal film and an inorganic insulating film.

(12) In an embodiment of the present invention, the liquid crystal display device includes the structure (1), (2), (3), (4), (5), (6), (7), (8), (9), (10), or (11), and the alignment film is a photoalignment film that has undergone alignment treatment through irradiation with polarized ultraviolet light.

(13) In an embodiment of the present invention, the liquid crystal display device includes the structure (1), (2), (3), (4), (5), (6), (7), (8), (9), (10), (11), or (12), and the step portion has a height greater than an average film thickness of the first alignment film.

(14) In an embodiment of the present invention, the liquid crystal display device includes the structure (1), (2), (3), (4), (5), (6), (7), (8), (9), (10), (11), (12), or (13), and the first substrate further includes a color filter layer.

(15) In an embodiment of the present invention, the liquid crystal display device includes the structure (1), (2), (3), (4), (5), (6), (7), (8), (9), (10), (11), (12), (13), or (14), and further includes: a first polarizing plate arranged adjacent to a surface of the first substrate opposite to the liquid crystal layer, the first polarizing plate having a first polarization axis which is parallel or perpendicular to the first direction; and a second polarizing plate arranged adjacent to a surface of the second substrate opposite to the liquid crystal layer, the second polarizing plate having a second polarization axis which is perpendicular to the first polarization axis.

The present disclosure can provide a liquid crystal display device capable of reducing or preventing a decrease in contrast ratio.

### BRIEF DESCRIPTION OF THE DRAWINGS

FIG. 1 is a schematic plan view of a liquid crystal display device according to Embodiment 1.

FIG. 2 is a schematic cross-sectional view of the liquid crystal display device according to Embodiment 1 taken along line A1-A2 in FIG. 1.

FIG. 3 is a schematic cross-sectional view of the liquid crystal display device according to Embodiment 1 taken along line B1-B2 in FIG. 1.

FIG. 4 is a schematic plan view of an FFS mode liquid crystal display device according to a comparative example in the case of containing liquid crystal molecules having a positive anisotropy of dielectric constant.

FIG. 5 is a schematic plan view of the FFS mode liquid crystal display device according to the comparative example in the case of containing liquid crystal molecules having a negative anisotropy of dielectric constant.

FIG. 6 is a plan view illustrating an angle α.

FIG. 7 is a cross-sectional view illustrating a taper angle.

FIG. 8 is a diagram illustrating the relationship between the inverse of the contact angle and the pre-tilt angle.

FIG. 9 is a schematic diagram showing the method of determining the taper angle β of a step portion consisting of one layer.

FIG. 10 is a schematic diagram showing the method of determining the taper angle β of a step portion consisting of two layers.

FIG. 11 is a schematic plan view of a liquid crystal display device according to Embodiment 2.

FIG. 12 is a schematic plan view of a liquid crystal display device according to Modified Example 1 of Embodiments 1 and 2.

FIG. 13 is a schematic plan view of a liquid crystal display device according to Modified Example 2 of Embodiments 1 and 2.

FIG. 14 is an example scanning electron micrograph of the liquid crystal display devices according to Examples 1 to 4.

### DETAILED DESCRIPTION OF THE INVENTION

Hereinbelow, embodiments of the present invention will be described. The present invention is not limited to the contents described in the following embodiments, and various design modifications may be made as long as they fall within the scope of the invention. In the following description, the same components or components having similar functions are denoted by the same reference signs across different drawings, and redundant descriptions thereof are omitted as appropriate. The various aspects of the present invention may also appropriately be combined as long as such combinations do not depart from the spirit of the invention.

Hereinbelow, embodiments of the present invention are described. The present invention is not limited to the contents described in the following embodiments, and various design modifications may be made as long as they fall within the scope of the invention.

### Embodiment 1

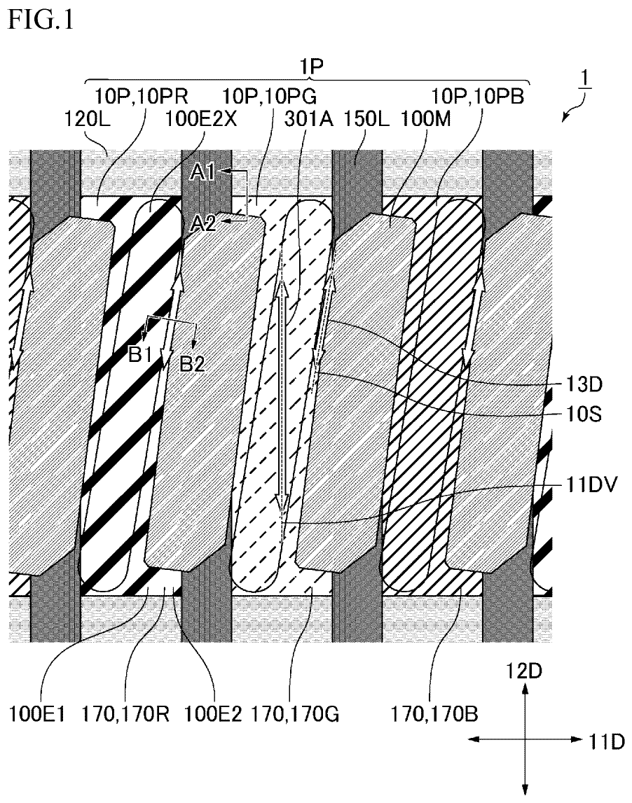

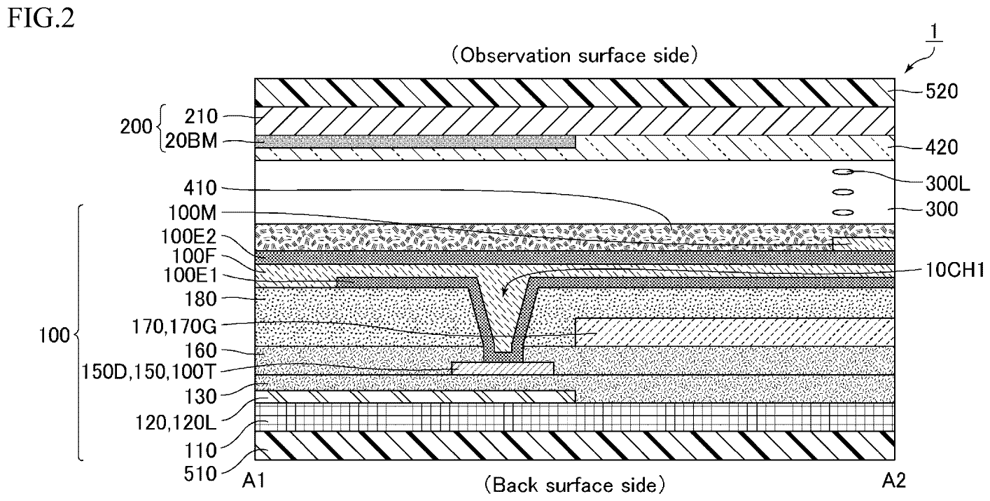

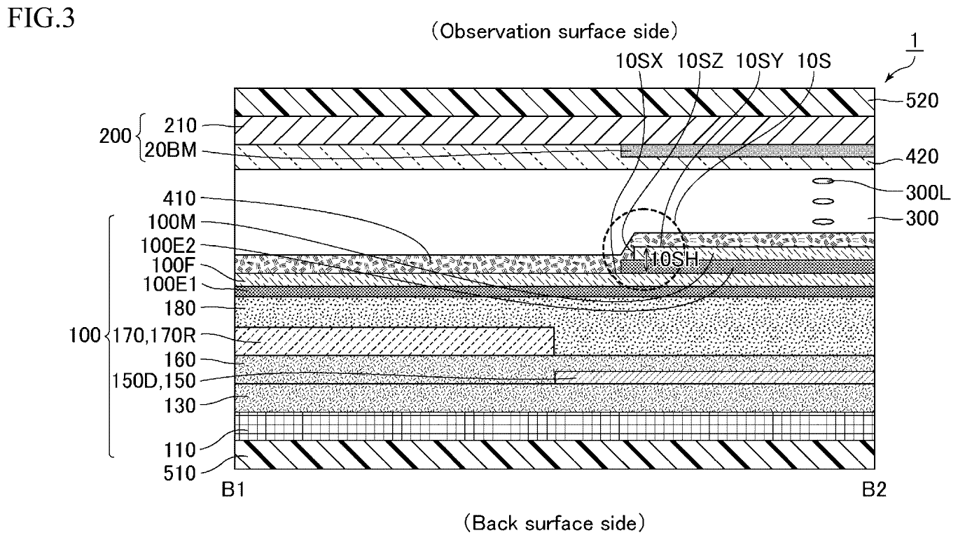

FIG. 1 is a schematic plan view of a liquid crystal display device according to Embodiment 1. FIG. 2 is a schematic cross-sectional view of the liquid crystal display device according to Embodiment 1 taken along line A1-A2 in FIG. 1. FIG. 3 is a schematic cross-sectional view of the liquid crystal display device according to Embodiment 1 taken along line B1-B2 in FIG. 1.

As shown in FIG. 1 to FIG. 3, a liquid crystal display device 1 of the present embodiment includes, in order: a first substrate 100 including gate lines 120L, source lines 150L, nonlinear elements 100T arranged corresponding to intersections of the gate lines 120L and the source lines 150L, a first electrode 100E1, and a second electrode 100E2; a first alignment film 410; a liquid crystal layer 300 containing liquid crystal molecules 300L; and a second substrate 200. The gate lines 120L extend in a first direction 11D. The source lines 150L extend in a second direction 12D which intersects the first direction 11D. The first electrode 100E1 and the second electrode 100E2 at least partially face each other across an insulating layer 100F. One electrode of the first electrode 100E1 and the second electrode 100E2 is connected to a source line 150L corresponding to the one electrode via a nonlinear element 100T corresponding to the one electrode among the nonlinear elements. The second electrode 100E2 is provided with elongated openings 100E2X. The first substrate 100 includes step portions 10S extending in a third direction 13D on a surface closer to the first alignment film 410. An angle α, defined in a plan view as an angle between the third direction 13D and an alignment direction (also referred to as reference alignment direction) 301A of liquid crystal molecules 300L located near the first alignment film 410 and within a central portion of each opening 100E2X with no voltage applied, is greater than 0° and less than 90°. A parameter P is 0.77 or less, as calculated based on the angle α, a taper angle β of the step portions 10S, and a contact angle θa of the first alignment film 410 with respect to pure water, in accordance with the following Equation (1). This configuration enables reduction or prevention of a decrease in contrast ratio of the liquid crystal display device 1. Here, the reference alignment direction 301A is the original alignment direction of the liquid crystal molecules, which is an alignment direction of the liquid crystal molecules with no voltage applied in regions not affected by any step portion 10S. The alignment direction of the liquid crystal molecules located near an alignment film and within the central portion of an opening with no voltage applied corresponds to the original alignment direction not affected by any step portion.

$$P = ( {θ}_{a} / 90 ° ) \times \{ 1 + 2 sin ( α ) \times cos ( α ) \} \times sin ( β ) \qquad ( 1 )$$

In Equation (1), when the taper angle β exceeds 90°, β in Equation (1) is set to 90°.

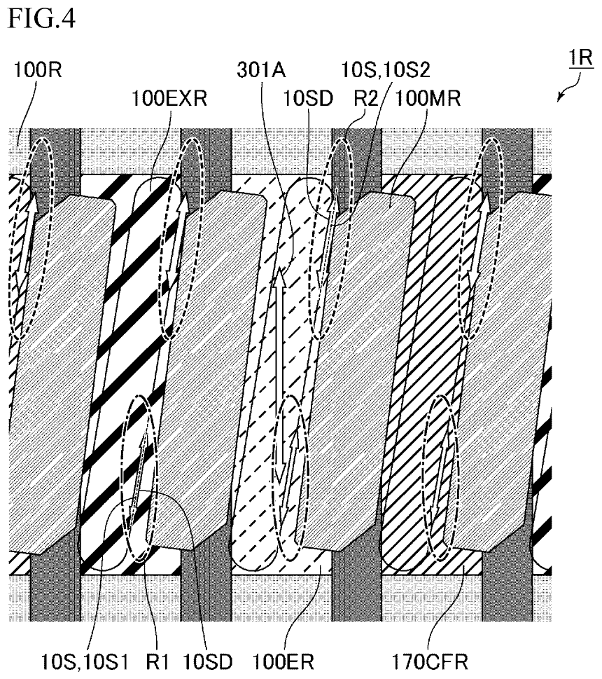

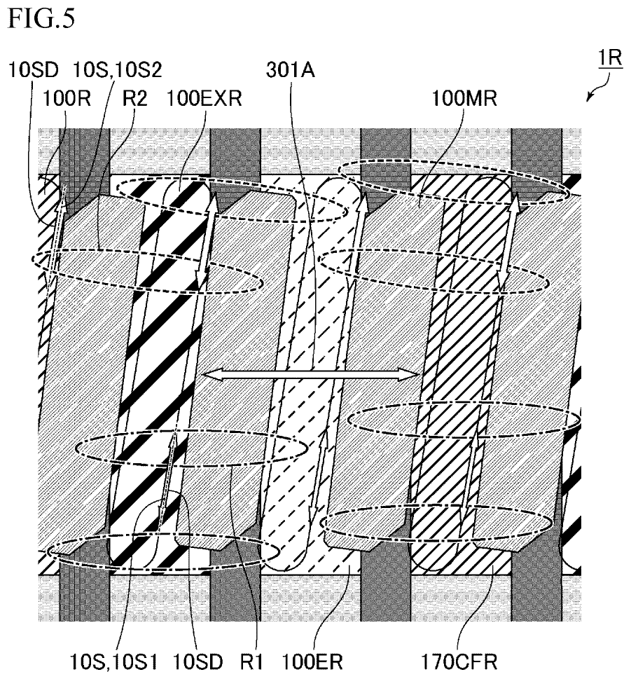

FIG. 4 is a schematic plan view of an FFS mode liquid crystal display device according to a comparative example in the case of containing liquid crystal molecules having a positive anisotropy of dielectric constant. FIG. 5 is a schematic plan view of the FFS mode liquid crystal display device according to the comparative example in the case of containing liquid crystal molecules having a negative anisotropy of dielectric constant. In a liquid crystal display device for head mounted displays, a fringe field switching (FFS) mode liquid crystal display device 1R shown in FIG. 4 and FIG. 5 can be used to reduce or prevent a color shift within a viewing angle.

In order to maintain a sufficient aperture area despite increased resolution, it is advantageous to form a color filter layer 170CFR on an array substrate 100R. However, when the color filter layer 170CFR is formed on the array substrate 100R, color mixing at oblique viewing angles is more likely to occur. The color mixing at oblique viewing angles can be reduced or prevented by partially covering the display area with a light-shielding film 100MR.

As shown in FIG. 4 and FIG. 5, projections and recesses (step portions 10S) are formed on the array substrate 100R due to the light-shielding film 100MR and slits (openings 100EXR) of the electrode 100ER arranged on the array substrate 100R. Additionally, in an overlapping region between an end of the light-shielding film 100MR and the boundary of a slit (opening 100EXR) of the electrode 100ER, a step portion 10S2 is formed, which is larger than a step portion 10S1 formed by the slit (opening 100EXR) of the electrode 100ER alone.

In a region where a step portion 10S is formed, the alignment direction (liquid crystal director) of the liquid crystal molecules possibly deviates from the original alignment direction (reference alignment direction 301A). In a region R2 where a larger step portion 10S2 is formed, the amount of deviation in alignment direction of liquid crystal molecules tends to be larger than in a region R1 where a smaller step portion 10S1 is formed. In some regions where a step portion 10S is formed, the alignment direction of the liquid crystal molecules may deviate from the original alignment direction, not toward an extension direction 10SD of the step portion 10S but in the opposite direction. In the liquid crystal display device 1R shown in FIG. 4 and FIG. 5, in some regions where a step portion 10S is formed, the deviation of the alignment direction of the liquid crystal molecules from the original alignment direction may cause a decrease in contrast ratio during black display.

As a result of studies, the inventors found that the decrease in contrast ratio is affected by step portions extending in a direction different from the original alignment direction (reference alignment direction) of the liquid crystal molecules, and the alignment film material (in particular, surface polarity).

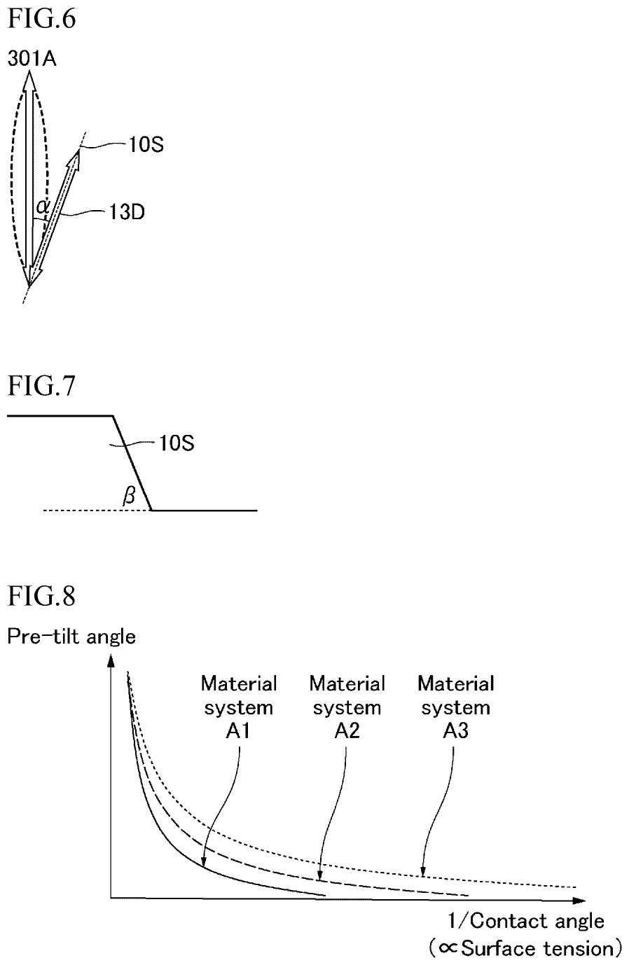

FIG. 6 is a plan view illustrating an angle α. FIG. 7 is a cross-sectional view illustrating a taper angle β. FIG. 6 and FIG. 7 illustrate the angle α and taper angle β in Equation (1). Occurrence of light leakage was found to depend on the following conditions (A) to (C). The angle α and taper angle β are shown in detail in FIG. 6 and FIG. 7, respectively. The contact angle (surface contact angle) θa of an alignment film can be measured with a contact angle meter using pure water as the medium.
(A) Surface property (contact angle θa) of the alignment film
(B) Angle α between the extension direction (third direction 13D) of step portions 10S and the original alignment direction (reference alignment direction 301A) in a plan view
(C) Taper angle β of the step portions 10S (β=90° in the case of a reverse taper)

The smaller the adsorption force of the liquid crystal molecules onto the alignment film surface, the lower the thermal stability of the alignment film. This presumably results in easier rotation of the liquid crystal molecules and further deviation of the alignment direction of the liquid crystal molecules from the original alignment direction (reference alignment direction 301A). In a plan view, when the angle between the extension direction (third direction 13D) of the step portions 10S and the original alignment direction (reference alignment direction 301A) of the liquid crystal molecules is 45°, the deviation presumably reaches its maximum. Similarly, the larger the taper angle β of the step portions 10S and the steeper the step portions 10S, the greater the presumed deviation of the alignment direction of the liquid crystal molecules from the original alignment direction (reference alignment direction 301A).

As a result of studies, the inventors found that the surface adsorption force of the alignment film and the properties of the step portions can be represented by the parameter P as defined in Equation (1), and that when the parameter P represented by Equation (1) is 0.77 or less, the decrease in contrast ratio of the liquid crystal display device can be reduced or prevented.

The term (θa/90°) in Equation (1) is a parameter that depends on the surface tension of the alignment film surface. The term {1+2 sin(α)×cos(α)} in Equation (1) indicates that when the angle formed between the extension direction (third direction 13D) of the step portions 10S and the reference alignment direction 301A of the liquid crystal molecules is 45°, the deviation of the alignment direction of the liquid crystal molecules near each step portion 10S from the reference alignment direction 301A (also referred to as phase deviation) reaches its maximum. The term sin(β) in Equation (1) indicates that the steeper the step portions 10S (the greater the taper angle), the greater the phase deviation.

The following describes the relationship between the contact angle (and its inverse) and the pre-tilt angle. FIG. 8 is a diagram illustrating the relationship between the inverse of the contact angle and the pre-tilt angle. As shown in FIG. 8, as the contact angle of the alignment film increases, the pre-tilt angle increases and becomes less dependent on the alignment film material (e.g., material system A1, material system A2, material system A3). Typically, the pre-tilt angle can be increased by introducing side chains into the material systems (polymeric materials).

As the contact angle of the alignment film decreases, the pre-tilt angle decreases and becomes more dependent on the alignment film material. As the contact angle decreases, the surface tension increases. A material system with a larger surface tension has a higher thermal stability.

Equation (1) represents a parameter related to the surface tension. A smaller parameter value means a greater surface tension. Also, the surface tension changes in response to the presence and shape (angle α, taper angle β) of the step portions. As a result, defects such as light leakage tend to occur depending on the conditions.

The pre-tilt angle herein refers to an angle of the long axes of liquid crystal molecules to a substrate surface with no voltage applied, wherein the substrate surface is set to 0° and the normal to the substrate is set to 90°. Herein, a state where a voltage equal to or higher than the threshold is applied between the first electrode and the second electrode (pixel electrode and common electrode) is referred to simply as “with voltage applied”, and a state where a voltage less than the threshold is applied between the first electrode and the second electrode (including a state where no voltage is applied) is referred to simply as “with no voltage applied”.

In JP 2007-248557 A, in an in-plane switching (IPS) mode liquid crystal display device, oblique conductive lines are eliminated in many pixel regions to increase the transmittance. However, the electrode structure disclosed in JP 2007-248557 A is very difficult to achieve in a high-definition liquid crystal display device used for head mounted displays, for example. Even if the structure is achieved, the alignment of the liquid crystal molecules may be unstable in regions where the pixel electrodes are not angled (in other words, regions where the outer edge of the pixel electrodes is parallel to the vertical direction or horizontal direction of the outer shape of the panel), which may possibly reduce operating speed. Thus, it is challenging to reduce or prevent a decrease in display contrast ratio in JP 2007-248557 A. Hereinbelow, the liquid crystal display device 1 of the present embodiment is described in detail.

As shown in FIG. 2 and FIG. 3, the liquid crystal display device 1 of the present embodiment includes the first substrate 100, the liquid crystal layer 300, and the second substrate 200 in order. In the present embodiment, the first substrate 100 is arranged on the back surface side, and the second substrate 200 is arranged on the viewing surface side, but the first substrate 100 may be arranged on the viewing surface side and the second substrate 200 on the back surface side.

The liquid crystal display device 1 includes the first alignment film 410 between the first substrate 100 and the liquid crystal layer 300. The liquid crystal display device 1 may include a second alignment film 420 between the second substrate 200 and the liquid crystal layer 300.

The liquid crystal display device 1 preferably includes a first polarizing plate 510 arranged adjacent to a surface of the first substrate 100 opposite to the liquid crystal layer 300, the first polarizing plate 510 having a first polarization axis which is parallel or perpendicular to the first direction 11D, and a second polarizing plate 520 arranged adjacent to a surface of the second substrate 200 opposite to the liquid crystal layer 300, the second polarizing plate 520 having a second polarization axis which is perpendicular to the first polarization axis.

Unless otherwise specified, herein, the expression that two straight lines (including polarization axes and directions) are perpendicular means that the angle formed between them is 87° or greater and 90° or less, preferably 89° or greater and 90° or less, more preferably 89.5° or greater and 90° or less, particularly preferably 90° (perfectly perpendicular). Also herein, the expression that two straight lines (including polarization axes and directions) are parallel means that the angle (absolute value) formed between them is 0° or greater and 3° or less, preferably 0° or greater and 1° or less, more preferably 0° or greater and 0.5° or less, particularly preferably 0° (perfectly parallel).

The liquid crystal display device 1 may further include a backlight on or near a surface of the first polarizing plate 510 opposite to the liquid crystal layer 300.

The liquid crystal display device 1 includes an active area (image display region) where images are displayed. The active area consists of sub-pixels 10P arranged in a matrix pattern in a horizontal direction of a screen (first direction 11D in the present embodiment) and a vertical direction of the screen (second direction 12D in the present embodiment).

The first substrate 100 includes a first supporting substrate 110; gate lines 120L extending parallel to each other in the first direction 11D adjacent to the surface of the first supporting substrate 110 facing the liquid crystal layer 300; a first insulating layer 130 arranged closer to the liquid crystal layer 300 than the gate lines 120L are; and source lines 150L extending parallel to each other in the second direction 12D adjacent to the surface of the first insulating layer 130 facing the liquid crystal layer 300. The gate lines 120L and the source lines 150L are formed in a grid pattern to partition the sub-pixels 10P. The nonlinear elements 100T are arranged corresponding to the intersections of the gate lines 120L and the source lines 150L. In the present embodiment, the first direction 11D is perpendicular to the second direction 12D. In the present embodiment, the first direction 11D corresponds to the row direction of the sub-pixels 10P arranged in a matrix pattern (hereinbelow, also referred to simply as “row direction”), and the second direction 12D corresponds to the column direction of the sub-pixels 10P arranged in a matrix pattern (hereinbelow, also referred to simply as “column direction”). However, the first direction 11D may correspond to the column direction of the sub-pixels 10P, and the second direction 12D to the row direction.

Each nonlinear element 100T is connected to a corresponding gate line 120L and a corresponding source line 150L among the gate lines 120L and the source lines 150L, and is a three-terminal switch (for example, thin film transistor (TFT)) including a gate electrode protruding from the corresponding gate line 120L (part of the corresponding gate line 120L), a source electrode protruding from the corresponding source line 150L (part of the corresponding source line 150L), a drain electrode 150D connected to a corresponding pixel electrode among the pixel electrodes (first electrode 100E1 in the present embodiment), and a semiconductor layer. The source electrode and the drain electrode 150D are arranged in a source line layer 150 including the source lines 150L. The gate electrode is arranged in a gate line layer 120 including the gate lines 120L. The first electrode 100E1 is connected to the drain electrode 150D through a through hole 10CH1.

The conductive lines constituting the gate lines 120L and the source lines 150L, and the electrodes constituting the nonlinear elements 100T can be formed by applying a metal such as copper, titanium, aluminum, molybdenum, or tungsten, or an alloy of any of these metals by sputtering or another process to form a single layer or multiple layers, followed by patterning the layer(s) by photolithography or another process. These conductive lines and electrodes that are formed in the same layer can be produced efficiently by using the same materials.

The first substrate 100 includes, in order toward the liquid crystal layer 300, the first supporting substrate 110, the gate line layer 120 including the gate lines 120L, the first insulating layer 130, the semiconductor layer, the source line layer 150 including the source lines 150L, a second insulating layer 160, a color filter layer 170, a planarization film 180, the first electrode 100E1, the insulating layer 100F, the second electrode 100E2 provided with the openings 100E2X, and the light-shielding film 100M.

The first insulating layer 130 is a gate insulating layer. The first insulating layer 130 is, for example, an inorganic insulating film. Examples of the inorganic insulating film include inorganic films (relative permittivity ε=5 to 7) such as silicon nitride (SiNₓ) films and silicon oxide (SiO₂) films, and a stack of any of these films.

The semiconductor layer is formed from, for example, a high-resistant semiconductor layer formed from amorphous silicon, polysilicon, or the like material, and a low-resistant semiconductor layer formed from n+ amorphous silicon, which is obtained by doping amorphous silicon with an impurity such as phosphorus, or the like material. The semiconductor layer may be an oxide semiconductor layer formed from indium gallium zinc oxide (IGZO) or the like material.

The second insulating layer 160 is, for example, an inorganic insulating film. Examples of the inorganic insulating film include inorganic films (relative permittivity ε=5 to 7) such as silicon nitride (SiNₓ) films and silicon oxide (SiO₂) films, and a stack of any of these films.

The first substrate 100 includes the color filter layer 170. The color filter layer 170 is arranged adjacent to a surface of the second insulating layer 160 facing the liquid crystal layer 300. The color filter layer 170 is composed of red color filters 170R, blue color filters 170B, and green color filters 170G.

The sub-pixels 10P include red sub-pixels 10PR including a red color filter 170R, blue sub-pixels 10PB including a blue color filter 170B, and green sub-pixels 10PG including a green color filter 170G. Three sub-pixels 10P of a red sub-pixel 10PR, a blue sub-pixel 10PB, and a green sub-pixel 10PG constitute one pixel 1P. Within one pixel 1P, these three sub-pixels 10P are arranged in a stripe pattern.

In the present embodiment, the color filter layer 170 is included in the first substrate 100. However, the color filter layer 170 may be included in the second substrate 200 rather than the first substrate 100.

The planarization film 180 is an insulating film that compensates for the projections and recesses of the surface (underlying layer) on which the film is formed and planarizes the substrate surface where the film is formed. The planarization film 180 can maintain a uniform cell thickness of the liquid crystal display device 1. An organic insulating film is suitable for the planarization film 180. Examples of the organic insulating film include acrylic resin films, polyimide resin films, and novolac resin films. The organic insulating film may be, for example, an organic film having a low relative permittivity (relative permittivity ε=2 to 5) such as a photosensitive acrylic resin film.

The first substrate 100 includes the first electrode 100E1 and the second electrode 100E2 provided with the openings 100E2X which at least partially face each other across the insulating layer 100F. In other words, the first substrate 100 includes the first electrode 100E1, the insulating layer 100F, and the second electrode 100E2 provided with the elongated openings 100E2X in order. This configuration can achieve an FFS mode display. One electrode of the first electrode 100E1 and the second electrode 100E2 is connected to a source line 150L corresponding to the one electrode through a nonlinear element 100T corresponding to the one electrode among the nonlinear elements. Here, the expression that the first electrode 100E1 and the second electrode 100E2 partially face each other means that at least part of the first electrode 100E1 faces at least part of the second electrode 100E2.

One electrode of the first electrode 100E1 and the second electrode 100E2 functions as pixel electrodes, and the other as a common electrode. In the present embodiment, the first electrode 100E1 functions as pixel electrodes, and the second electrode 100E2 functions as a common electrode.

The pixel electrodes are arranged in the respective regions each surrounded by adjacent two gate lines 120L and adjacent two source lines 150L. The pixel electrodes are arranged in the respective sub-pixels 10P. Each pixel electrode is connected to a corresponding nonlinear element 100T, and is connected to a corresponding source line 150L through the semiconductor layer in the nonlinear element 100T. The pixel electrode is set at an electrical potential corresponding to the data signal supplied thereto through the corresponding nonlinear element 100T.

The common electrode is, for example, formed across substantially the entire surface regardless of the boundaries between the sub-pixels 10P. Common signals of a constant value are supplied to the common electrode, so that the common electrode is maintained at a constant electrical potential.

The second electrode 100E2 is provided with one or more openings 100E2X. The openings 100E2X are formed in the respective sub-pixels 10P, with one opening per sub-pixel.

The second electrode 100E2 is preferably arranged closer to the liquid crystal layer 300 than the first electrode 100E1 is. The openings 100E2X of the second electrode 100E2 (as an upper layer) arranged closer to the liquid crystal layer 300 are positioned above the first electrode 100E1 as a lower layer. In the present embodiment, the lower-layer first electrode 100E1 is arranged at least in a region corresponding to an opening 100E2X. Yet, there may be a region that corresponds to an opening 100E2X but does not include the first electrode 100E1. For example, when the lower-layer first electrode 100E1 functions as the common electrode, the first electrode 100E1 may be a solid electrode provided with openings in regions corresponding to through holes that connect the upper-layer second electrode 100E2 functioning as the pixel electrodes and the drain electrodes of the nonlinear elements 100T. The electric field applied to the liquid crystal molecules is determined by the difference in electric potential between the openings 100E2X of the upper-layer second electrode 100E2 and the lower-layer first electrode 100E1. Thus, in terms of the behavior of the liquid crystal molecules, either the upper-layer electrode (second electrode 100E2) or the lower-layer electrode (first electrode 100E1) may function as the pixel electrodes or the common electrode. When the upper-layer electrode corresponds to the pixel electrodes, adjacent pixel electrodes need to be electrically insulated. Thus, the upper-layer electrode has a structure in which, for example, each of quadrangular pixel electrodes is provided with one opening 100E2X. On the other hand, when the upper-layer electrode corresponds to the common electrode, the upper-layer electrode has a structure in which a solid electrode extending across the entire screen region is provided with one opening per region corresponding to each sub-pixel (in other words, the number of openings corresponds to the number of sub-pixels across the entire common electrode).

Preferably, the second electrode 100E2 is arranged closer to the liquid crystal layer 300 than the first electrode 100E1 is, and the first electrode 100E1 functions as the pixel electrodes while the second electrode 100E2 functions as the common electrode. This configuration can make the steps formed by the electrodes smaller and facilitate formation of through holes between the pixel electrodes and the drain electrodes. The second electrode 100E2 may also be arranged closer to the liquid crystal layer 300 than the first electrode 100E1 is, and the first electrode 100E1 may function as the common electrode while the second electrode 100E2 may function as the pixel electrodes. This configuration can make the parasitic capacitance [Cgd] of the nonlinear elements 100T smaller.

The second electrode 100E2 has a thickness of preferably 30 nm or more and 150 nm or less, more preferably 30 nm or more and 100 nm or less, still more preferably 30 nm or more and 80 nm or less. As shown in FIG. 4 and FIG. 5, due to the steps in the openings 100EXR of the electrode 100ER, the alignment direction of the liquid crystal molecules near each step with no voltage applied seems to deviate from the predicted alignment direction (reference alignment direction 301A) to cause a decrease in contrast ratio. However, the configuration of the present embodiment can reduce or prevent the decrease in contrast ratio even when the second electrode 100E2 has a thickness of 30 nm or more and 150 nm or less.

The first electrode 100E1 and the second electrode 100E2 can be formed by, for example, forming a single layer or multiple layers from a transparent conductive material such as indium tin oxide (ITO), indium zinc oxide (IZO), zinc oxide (ZnO), or tin oxide (SnO), or from an alloy of any of these materials by sputtering or the like, followed by patterning the layer(s) by photolithography.

The insulating layer 100F is an interlayer insulating film and has a function of insulating between the first electrode 100E1 and the second electrode 100E2. The insulating layer 100F can be an inorganic insulating film. Examples of the inorganic insulating film include inorganic films (relative permittivity ε=5 to 7) such as silicon nitride (SiNₓ) films and silicon oxide (SiO₂) films, and a stack of any of these films.

The light-shielding film 100M preferably has an elongated shape. More preferably, the light-shielding film 100M is arranged in an island pattern such that it at least partially overlaps with the source lines 150L between the sub-pixels 10P (in the boundaries between the sub-pixels 10P). This configuration can reduce or prevent a color shift during single-color display due to light leakage from between adjacent sub-pixels 10P mainly at oblique viewing angles.

The light-shielding film 100M preferably contains metal. The metal contained in the light-shielding film 100M is preferably a metal having a relatively low reflectance, such as molybdenum or titanium. The light-shielding film 100M may contain a substance other than metal. The light-shielding film 100M is, for example, a metal film or a laminate including a metal film and an inorganic insulating film. The laminate may include, for example, an insulating film such as a silicon oxide film, a silicon nitride film, or the like between multiple metal films. When the light-shielding film 100M is a laminate, the metal films in the laminate are preferably semi-transparent metal thin film layers. This configuration can reduce the reflectance of the light-shielding film 100M using light interference.

The light-shielding film 100M has a thickness of preferably 40 nm or more and 250 nm or less, more preferably 100 nm or more and 250 nm or less, still more preferably 150 nm or more and 200 nm or less. As shown in FIG. 4 and FIG. 5, the steps due to the light-shielding film 100MR seem to cause the alignment direction of the liquid crystal molecules near these steps with no voltage applied to deviate from the predicted alignment direction (reference alignment direction 301A), causing a decrease in contrast ratio. However, the configuration of the present embodiment can reduce or prevent the decrease in contrast ratio even when the light-shielding film 100M has a thickness of 40 nm or more and 250 nm or less.

The sum of the thickness of the second electrode 100E2 and the thickness of the light-shielding film 100M is preferably 70 nm or more and 400 nm or less, more preferably 130 nm or more and 350 nm or less, still more preferably 180 nm or more and 280 nm or less.

As shown in FIG. 3, the first substrate 100 includes the step portions 10S extending in the third direction 13D on the surface closer to the first alignment film 410. The step portions 10S each include a first face 10SX, a second face 10SY that is located adjacent to the first face 10SX and closer to the liquid crystal layer 300 than the first face 10SX is, and a third face 10SZ (for example, inclined surface) which connects the first face 10SX and the second face 10SY The third direction 13D is a direction in which the boundary between the third face 10SZ and one of the first face 10SX and the second face 10SY extends.

Examples of the step portions 10S include the following three types of step portions (I) to (III).
(I) A step corresponding to the thickness of the light-shielding film 100M. In other words, this step portion 10S includes an end of the light-shielding film 100M.
(II) A step corresponding to the thickness of the second electrode 100E2, formed by an opening 100E2X of the second electrode 100E2. In other words, this step portion 10S includes an end of the opening 100E2X of the second electrode 100E2.
(III) A step corresponding to the sum of the thickness of the light-shielding film 100M and the thickness of the second electrode 100E2, formed by the light-shielding film 100M and the opening 100E2X of the second electrode 100E2. In other words, this step portion 10S includes an end of the light-shielding film 100M and an end of the opening 100E2X of the second electrode 100E2. The distance between the end of the light-shielding film 100M and the end of the opening 100E2X in the step portion 10S is, for example, 0 nm or longer and 500 nm or shorter. When the distance is 0 nm or longer and 500 nm or shorter, the step portion 10S is steep and thus likely to cause misalignment of the liquid crystal molecules 300L. Still, setting the parameter P represented by Equation (1) to 0.77 or less enables reduction or prevention of a decrease in contrast ratio of the liquid crystal display device 1.

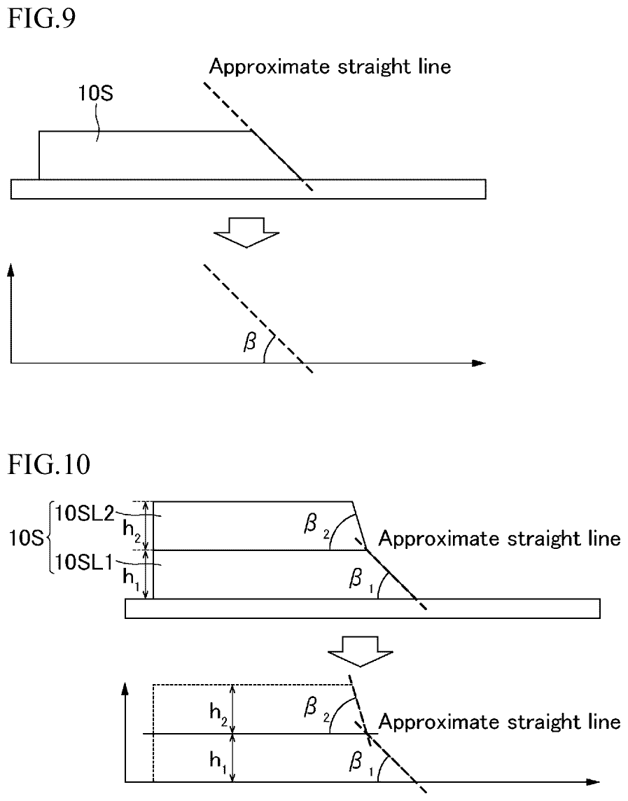

FIG. 9 is a schematic diagram showing the method of determining the taper angle β of a step portion consisting of one layer. FIG. 10 is a schematic diagram showing the method of determining the taper angle β of a step portion consisting of two layers.

When the step portions 10S each consist of one layer, in other words, when the step portions 10S are of the type (I) or (II), the taper angle β of the step portions 10S can be determined by, as shown in FIG. 9, drawing an approximate straight line along the slope of a step portion 10S. The approximate straight line can be determined by the least squares method.

When the step portions 10S each consist of two layers (lower layer 10SL1 and upper layer 10SL2), in other words, when the step portion 10S is of the type (III), the taper angle β can be determined by the method shown in FIG. 10. In other words, a taper angle β₁ is determined by drawing an approximate straight line along the slope of the lower layer 10SL1, which has a height h₁. Similarly, a taper angle β₂ is determined by drawing an approximate straight line along the slope of the upper layer 10SL2, which has a height h₂. An average angle βₐᵥₑ, which is obtainable from the following Equation (2) using the taper angle β₁ and the taper angle β₂, can be set as the taper angle J. The approximate straight line can be determined by the least squares method.

$${β}_{ave .} = {β}_{1} ( {h}_{1} / ( {h}_{1} + {h}_{2} ) ) + {β}_{2} ( {h}_{2} / ( {h}_{1} + {h}_{2} ) ) \qquad ( 2 )$$

As shown in FIG. 3, a height 10SH of the step portions 10S is preferably greater than the average film thickness of the first alignment film 410. When the height 10SH of the step portions 10S is greater than the average film thickness of the first alignment film 410, the liquid crystal molecules 300L near such a step portion 10S tends to be misaligned and thus the contrast ratio tends to decrease. Yet, the liquid crystal display device 1 of the present embodiment can effectively reduce or prevent the decrease in contrast ratio.

The height of the step portions 10S corresponds to the level difference between the first face 10SX and the second face 10SY of each step portion 10S. The height of the step portions can be determined by fracturing the liquid crystal panel (liquid crystal display device), removing the liquid crystal layer, and observing a cross section of the step portions on the first substrate using a scanning electron microscope (SEM).

The film thickness of the first alignment film can be determined by fracturing the liquid crystal panel (liquid crystal display device), removing the liquid crystal layer, and observing a cross section of the alignment film on the first substrate using a SEM. The film thickness is measured at three locations on the first alignment film, and the average of these measurements is calculated and defined as the average film thickness of the first alignment film.

The second substrate 200 includes a second supporting substrate 210.

The second substrate 200 may include a second substrate-side light-shielding film 20BM arranged adjacent to a surface of the second supporting substrate 210 facing the liquid crystal layer 300. The second substrate-side light-shielding film 20BM may be arranged in a grid pattern to partition the color filters, for example.

The second substrate-side light-shielding film 20BM is, for example, a black matrix layer. The material of the black matrix layer may be any material having a light-shielding property. Suitable examples include a resin material containing a black pigment and a metal material having a light-shielding property. The black matrix layer can be formed, for example, by photolithography including applying a photosensitive resin containing a black pigment to form a film, exposing the film to light, and developing the film, for example.

Preferably, the second substrate-side light-shielding film 20BM is arranged to extend along the row direction (in the present embodiment, the first direction 11D) between two sub-pixels 10P adjacent to each other in the column direction (in the present embodiment, the second direction 12D), and is not arranged between two sub-pixels 10P adjacent to each other in the row direction (does not extend along the column direction between two subpixels 10P adjacent to each other in the row direction). This configuration can reduce or prevent peeling of the second substrate-side light-shielding film 20BM as compared to when the second substrate-side light-shielding film 20BM is arranged to extend both between two sub-pixels 10P adjacent to each other in the column direction and between two sub-pixels 10P adjacent to each other in the row direction. Also, in terms of the accuracy of positional alignment when the first substrate 100 and the second substrate 200 are attached to each other, this configuration can increase the aperture ratio as compared to when the second substrate-side light-shielding film 20BM extends in the column direction. The second substrate-side light-shielding film 20BM, for example, extends along the outer frame of the display screen of the liquid crystal display device 1 and between the sub-pixels 10P in the row direction.

Spacers may be arranged between the first substrate 100 and the second substrate 200. The spacers have a function of maintaining a sufficient gap where the liquid crystal layer 300 is formed. The spacers have a columnar shape, for example. The spacers are arranged on at least one of the first substrate 100 or the second substrate 200, and may be arranged on both substrates. The spacers, for example, are arranged on the second substrate 200, and the tips of the spacers are not necessarily in contact with the first substrate 100. The spacers may have, for example, a polygonal, circular, or oval planar shape. The spacers have a shape such as a truncated cone, a cylinder, a truncated elliptical cone, an elliptical cylinder, a truncated polygonal pyramid, or a polygonal prism. Examples of the truncated polygonal pyramid include a truncated square pyramid. Examples of the polygonal prism include a square prism.

Spacers 500 preferably contain a cured product of a photosensitive resin, for example. Examples of the photosensitive resin include resins having a UV-reactive functional group.

The liquid crystal layer 300 contains a liquid crystal material. The amount of light transmitted therethrough is controlled by applying voltage to the liquid crystal layer 300 and changing the alignment state of the liquid crystal molecules 300L in the liquid crystal material in response to the applied voltage. The liquid crystal material exhibits nematic liquid crystallinity within a certain temperature range.

The anisotropy of dielectric constant (Δε) of the liquid crystal molecules 300L, represented by the following Equation (L1), may be positive or negative. The liquid crystal molecules 300L in the present embodiment have a positive anisotropy of dielectric constant. This configuration can increase the response speed.

Δε=(dielectric constant in long axis direction of liquid crystal molecules)−(dielectric constant in short axis direction of liquid crystal molecules) Equation (L1)

The liquid crystal molecules 300L may also be referred to as a positive liquid crystal in the case of having a positive anisotropy of dielectric constant. The liquid crystal molecules 300L may also be referred to as a negative liquid crystal in the case of having a negative anisotropy of dielectric constant. The long axis direction of the liquid crystal molecules 300L is defined as the alignment direction (slow axis direction). In addition, the liquid crystal molecules 300L are homogeneously aligned, in a state where voltage is not applied between the first electrode 100E1 and the second electrode 100E2 (with no voltage applied).

The liquid crystal molecules 300L are horizontally aligned when no voltage is applied. The expression that the liquid crystal molecules 300L are horizontally aligned means that when no voltage is applied to the liquid crystal layer 300 (when the voltage applied to the liquid crystal layer 300 is lower than the threshold voltage), the liquid crystal molecules 300L in the liquid crystal layer 300 are aligned substantially parallel to the main surfaces of the first substrate 100 and the second substrate 200. Here, the expression that the liquid crystal molecules are aligned substantially parallel to the main surfaces of the substrates means that the pre-tilt angle of the liquid crystal molecules relative to the main surfaces of the substrates is 0° or greater and 5° or less, preferably 0° or greater and 2° or less, more preferably 0° or greater and 1° or less.

The liquid crystal display device 1 includes the first alignment film 410 arranged between the first substrate 100 and the liquid crystal layer 300. The liquid crystal display device 1 may include the second alignment film 420 arranged between the second substrate 200 and the liquid crystal layer 300. The first alignment film 410 and the second alignment film 420 each have a function of controlling the alignment of the liquid crystal molecules 300L in the liquid crystal layer 300. The first alignment film 410 and the second alignment film 420 are horizontal alignment films.

A horizontal alignment film has a function of aligning, when no voltage is applied to the liquid crystal layer, the liquid crystal molecules in the liquid crystal layer in a direction substantially parallel to the main surfaces of the horizontal alignment film (substrate). A vertical alignment film has a function of aligning, when no voltage is applied to the liquid crystal layer, the liquid crystal molecules in the liquid crystal layer in a direction substantially vertical to the main surfaces of the vertical alignment film (substrate). Here, the expression that the liquid crystal molecules are aligned in a direction substantially vertical to the main surfaces of the vertical alignment film (substrate) means that the pre-tilt angle of the liquid crystal molecules relative to the main surfaces of the substrate is 80° or greater and 90° or less, preferably 85° or greater and 90° or less, more preferably 88° or greater and 90° or less.

Although depending on the shape of the step portions 10S and the relationship between the extension direction of the step portions 10S and the azimuth of the liquid crystal directors, the contact angle θa of the first alignment film 410 is preferably 1° or greater and 40° or less, more preferably 7° or greater and 15° or less. This configuration enables the liquid crystal display device 1 to have a sufficient transmittance owing to the pre-tilt angle being suppressed and to have a sufficient thermal stability.

The first alignment film 410 has an average film thickness of preferably 20 nm or more and 300 nm or less, more preferably 35 nm or more and 250 nm or less, still more preferably 50 nm or more and 200 nm or less. This configuration can achieve a high transmittance and a favorable alignment controllability, reducing or preventing light leakage in a light-off state.

Examples of alignment treatment methods for the first alignment film 410 include a method in which the alignment film is irradiated with polarized ultraviolet light to cleave polymer chains in a certain direction of the alignment film (degradation photoalignment method), a method in which the alignment film is irradiated with polarized ultraviolet light to induce cis-trans isomerization reaction of the photofunctional groups in the alignment film (isomerization photoalignment method), and a method in which the surface of the alignment film is rubbed using cloth with raised fibers to increase the proportion of the polymer chains aligning in a certain direction on the surface (rubbing alignment method).

The first alignment film 410 is preferably a photoalignment film that has undergone alignment treatment through irradiation with polarized ultraviolet light. This configuration can achieve effective alignment treatment on the first alignment film 410 arranged on the first substrate 100 including the step portions 10S. The first alignment film 410 can be, for example, a photodegradable polyimide-based alignment film such as an RB-series product available from Nissan Chemical Corporation.

The second alignment film 420 is the same as the first alignment film 410.

The angle α, defined in a plan view as the angle between the third direction 13D and the alignment direction (reference alignment direction) 301A of the liquid crystal molecules 300L located near the first alignment film 410 and within the central portions of the openings 100E2X with no voltage applied, is greater than 0° and less than 90°.

The central portion of an opening refers to a region where the central portion (a region with a certain range) of the opening in the longitudinal direction overlaps with the central portion (a region with a certain range) of the opening in the transverse direction (the direction forming an angle of 90° with the longitudinal direction). The central portion of the opening in the longitudinal direction refers, for example, to the central region among three regions obtained by dividing the opening equally along the longitudinal direction. The central portion of the opening in the transverse direction refers, for example, to the central region among three regions obtained by dividing the opening equally along the transverse direction.

The alignment direction of the liquid crystal molecules with no voltage applied can be identified in the following manner. Since an alignment film (for example, an alignment film obtained using a generally used thermally resistant polymer) has a phase difference in the alignment direction of the liquid crystal molecules, the direction of the phase difference of the alignment film measured with a microscopic polarization measurement system (for example, microscopic polarized spectrophotometer (TFM-120AFT-PC available from Orc Manufacturing Co., Ltd.)) can be defined as the alignment direction of the liquid crystal molecules with no voltage applied. When the alignment film exhibits a minute phase difference whose direction is difficult to determine, a laminate including, in order, an alignment film, a liquid crystal layer containing liquid crystal molecules, and a polarizing plate is irradiated, from the direction of the alignment film, with polarized light whose polarization axis is at an angle of 90° relative to the transmission axis of the polarizing plate. The direction in which the transmittance reaches its minimum can then be defined as the alignment direction of the liquid crystal molecules with no voltage applied.

The parameter P represented by Equation (1) is preferably 0.074 or more. This configuration can reduce or prevent the decrease in contrast ratio of the liquid crystal display device 1 and also can reduce or prevent light leakage.

Among the liquid crystal molecules 300L, liquid crystal molecules 300L located near the first alignment film 410 are preferably at a pre-tilt angle of 0° or greater and 3° or less. This configuration can achieve a sufficient luminance while reducing power consumption. If the pre-tilt angle exceeds 3°, the transmittance may be low in a transverse electric field display mode.

The taper angle β of the step portions 10S is preferably 60° or greater and 90° or less. This configuration can increase the transmittance and widen the movable region of the liquid crystal molecules 300L. When the step portions 10S are made more gentle (for example, the taper angle β is made greater than 0° and less than 60°), the light-shielding regions will be wider and the openings 100E2X in the second electrode 100E2 will also be wider, which may result in a decrease in transmittance and reduction of the movable region of the liquid crystal molecules 300L.

In a plan view, the alignment direction 301A of the liquid crystal molecules 300L located near the first alignment film 410 and within the central portions of the openings 100E2X with no voltage applied is preferably parallel or perpendicular to the first direction 11D. This configuration can further reduce or prevent the decrease in contrast ratio of the liquid crystal display device 1.

Preferably, the liquid crystal molecules 300L have a positive anisotropy of dielectric constant, the alignment direction 301A in a plan view of the liquid crystal molecules 300L located near the first alignment film 410 and within the central portions of the openings 100E2X with no voltage applied is perpendicular to the first direction 11D, and the angle α is 3° or greater and 45° or less. This configuration can effectively reduce or prevent the decrease in contrast ratio.

When the angle α is 0°, light leakage does not occur regardless of the surface adsorption force of the first alignment film 410. Meanwhile, when the angle α exceeds 45°, although the response properties are satisfactory, the liquid crystal molecules exhibit only slight in-plane switching, which may possibly result in a low transmittance.

In a plan view, the alignment direction of the liquid crystal molecules 300L located near the second substrate 200 and within the central portions of the openings 100E2X with no voltage applied is preferably perpendicular to the first direction 11D. This configuration can further reduce or prevent the decrease in contrast ratio of the liquid crystal display device 1.

The liquid crystal display device 1 includes a gate driver connected to the gate lines 120L, a source driver connected to the source lines 150L, and a controller connected to the gate driver and the source driver. The gate driver sequentially supplies scanning signals to the gate lines 120L under the control by the controller. The source driver supplies data signals to the source lines 150L under the control by the controller when the corresponding nonlinear element 100T switches, in response to a scanning signal, into the state with voltage applied.

The pixel electrodes are each set at an electrical potential corresponding to the data signal supplied through the corresponding nonlinear element 100T. Then, a fringe electric field is generated between the common electrode and the pixel electrodes to rotate the liquid crystal molecules 300L in the liquid crystal layer 300. In this manner, the magnitude of voltage applied between the common electrode and the pixel electrodes is controlled, so that the retardation of the liquid crystal layer 300 can be varied to control the transmission or blocking of light. The liquid crystal display device 1 of the present embodiment is a fringe field switching (FFS) mode liquid crystal display device.

### Embodiment 2

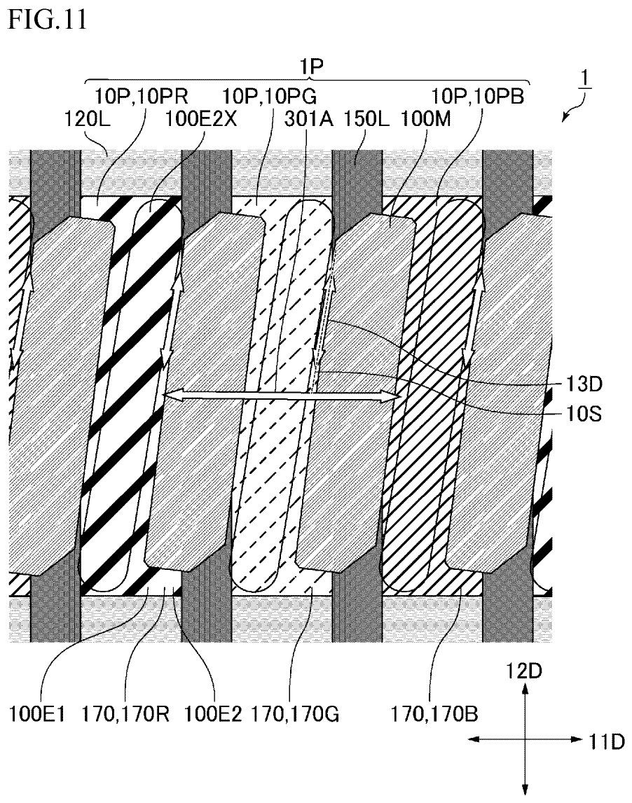

In the present embodiment, features unique to the present embodiment are mainly described, and descriptions of the same contents as in Embodiment 1 are omitted. FIG. 11 is a schematic plan view of a liquid crystal display device according to Embodiment 2. The present embodiment is substantially the same as Embodiment 1, except that the liquid crystal molecules 300L have a different anisotropy of dielectric constant. While the liquid crystal molecules 300L in the liquid crystal display device 1 of Embodiment 1 have a positive anisotropy of dielectric constant, the liquid crystal molecules 300L in the present embodiment have a negative anisotropy of dielectric constant. This configuration also can reduce or prevent the decrease in contrast ratio of the liquid crystal display device 1.

Preferably, the liquid crystal molecules 300L have a negative anisotropy of dielectric constant, and as shown in FIG. 11, the alignment direction 301A in a plan view of the liquid crystal molecules 300L located near the first alignment film 410 and within the central portions of the openings 100E2X with no voltage applied is parallel to the first direction 11D, and the angle α is 45° or greater and 87° or less. This configuration can effectively reduce or prevent the decrease in contrast ratio. Moreover, the configuration can increase the transmittance.

In a plan view, the alignment direction of the liquid crystal molecules 300L located near the second substrate 200 and within the central portions of the openings 100E2X with no voltage applied is preferably parallel to the first direction 11D. This configuration can further reduce or prevent the decrease in contrast ratio of the liquid crystal display device 1.

### Modified Example 1 of Embodiments 1 and 2

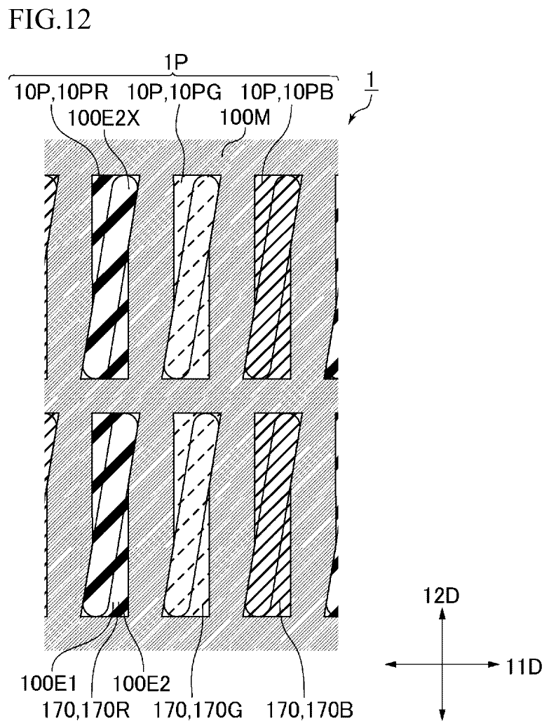

FIG. 12 is a schematic plan view of a liquid crystal display device according to Modified Example 1 of Embodiments 1 and 2. The light-shielding film 100M may, as shown in FIG. 12, be arranged in a grid pattern overlaid on the gate lines 120L and the source lines 150L.

### Modified Example 2 of Embodiments 1 and 2

In Embodiments 1 and 2, the second direction 12D is perpendicular to the first direction 11D which corresponds to the row direction. However, the second direction 12D may not be perpendicular to the first direction 11D (in other words, the second direction 12D may be inclined relative to the column direction).

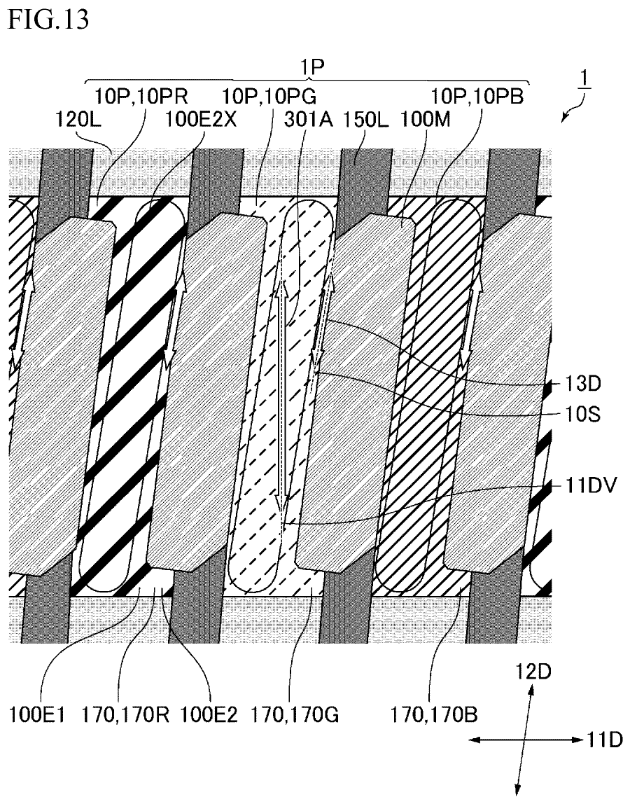

FIG. 13 is a schematic plan view of a liquid crystal display device according to Modified Example 2 of Embodiments 1 and 2. As shown in FIG. 13, the second direction 12D is inclined relative to the column direction (the top-bottom direction of the figure). In the present modified example, the first direction 11D corresponds to the row direction as in Embodiments 1 and 2. The angle formed between the first direction 11D and the second direction 12D is preferably 70° or greater and 95° or less, preferably 75° or greater and 92° or less, more preferably 80° or greater and 90° or less. This configuration can increase the aperture ratio of the sub-pixels 10P.

In the present modified example, to align the inclination directions of the openings 100E2X, the source lines 150L are formed in a zig-zag shape with bends near the gate electrodes. In the present modified example, the source lines 150L locally extend in a direction inclined relative to the column direction as shown in FIG. 13. However, when viewed as a whole, the source lines 150L extend along the column direction. In other words, the longitudinal direction of the source lines 150L runs along the column direction from one end to the other end.

The source electrodes (source lines 150L) have a thickness of 300 nm or more and 550 nm or less, for example. As a result, even after the color filter layer 170 and the planarization film 180 are formed, the steps due to the source electrodes still affect the surface. However, the configuration of the present modified example can increase the display contrast ratio.

### EXAMPLES

The following describes the effect of the present invention based on examples, comparative examples, and reference examples. These examples are not intended to limit the present invention.

### Examples 1 to 4

Liquid crystal display devices 1 of Examples 1 to 4 which correspond to the liquid crystal display device 1 of Embodiment 1 were produced. The resolutions of the liquid crystal display devices 1 of Examples 1 to 4 were 1400 ppi. Each pixel 1P had a size of 18-μm square, and each sub-pixel 10P had a size of 6 μm×18 μm. Each liquid crystal display device had the electrode slits (openings 100E2X) and the light-shielding film 100M for prevention of color mixing at oblique viewing angles.

The gate lines 120L were formed on the first supporting substrate 110, and then a gate insulating layer (first insulating layer 130) and thin-film transistors (nonlinear elements 100T) were formed, followed by formation of the source lines 150L. The source lines 150L also functioned as a light-shielding film between the sub-pixels 10P.

Next, on the source lines 150L, the color filter layer 170 including color filters of multiple colors (red color filters 170R, blue color filters 170B, and green color filters 170G) was formed using colored organic resists. Two color filters adjacent to each other in the row direction among the color filters of multiple colors were formed to be substantially flush with each other, continuously along the central region in the transverse direction of the source lines 150L. Color filters of each color were continuously formed across the gate lines 120L in the column direction. The planarization film 180, which is an organic planarization film, was arranged adjacent to the surface of the color filter layer 170 facing the liquid crystal layer 300. With the planarization film 180 formed on the color filter layer 170, a flat surface was successfully formed.

Next, the through holes (contact holes) 10CH1, through which the pixel electrodes (first electrode 100E1) and the drain electrodes 150D of the thin-film transistors are to be electrically connected, were formed, penetrating the color filter layer 170 and the planarization film 180.

Thereon were formed the first electrode 100E1 (pixel electrodes), the insulating layer 100F, and the second electrode 100E2 (common electrode) in order to display images in the FFS mode. The light-shielding film 100M was then formed to produce the first substrate 100. Additionally, on the light-shielding film 100M, the first alignment film 410 was formed. The first alignment films 410 in Examples 1 to 4 were the following alignment films A to D, respectively.

The alignment film A was a horizontal polyimide photoalignment film. The alignment film B was also a horizontal polyimide photoalignment film, but of a different photoreaction type than the alignment film A. The alignment film C was a horizontal polyimide rubbing alignment film. The alignment film D was a horizontal polysiloxane photoalignment film. The alignment films A and B were different in irradiation wavelength used during photoalignment treatment; the alignment film A was irradiated with light having a deep ultraviolet wavelength for alignment treatment, while the alignment film B was irradiated with light having an ultraviolet wavelength for alignment treatment.

The horizontal polyimide photoalignment film refers to a horizontal alignment film that contains a polymer with a polyimide structure in its main chain and undergoes alignment treatment through photoirradiation. The horizontal polyimide rubbing alignment film refers to a horizontal alignment film that contains a polymer with a polyimide structure in its main chain and undergoes alignment treatment through rubbing. The horizontal polysiloxane photoalignment film refers to a horizontal alignment film that contains a polymer with a polysiloxane structure in its main chain and undergoes alignment treatment through photoirradiation.

The second electrode 100E2 was provided with slits (openings 100E2X) that, in a plan view, were inclined 15° clockwise relative to the direction vertical to the transverse direction of the panel outer shape (specifically, direction 11DV vertical to the first direction 11D; in the drawings, vertical direction). The direction vertical to the first direction refers to a direction that forms an angle of 90° with the first direction. In other words, the angle formed between the first direction 11D and the third direction 13D was 75°. Also, to reduce interference with the slits, the light-shielding film 100M whose main sides (longitudinal direction) were oriented in the same direction was formed.

The alignment films A, B, and D were photoalignment films that align the liquid crystal molecules 300L in a direction vertical to the transmitted polarized light through irradiation with polarized ultraviolet light. The alignment film C was a rubbing alignment film that aligns the liquid crystal molecules 300L through rubbing with a rubbing cloth or the like. The alignment treatment was performed on the first alignment film 410 such that, in a plan view, the alignment direction 301A in a plan view of the liquid crystal molecules 300L located near the first alignment film 410 (first substrate 100) and within the central portions of the openings 100E2X with no voltage applied would be a direction vertical to the transverse direction of the panel outer shape (specifically, direction 11DV vertical to the first direction 11D). In other words, the angle formed between the first direction 11D and the alignment direction 301A was 90°.

As described above, in the liquid crystal display devices 1 of Examples 1 to 4, the alignment direction 301A was perpendicular to the first direction 11D, and the angle α was 15°.

Next, on the second supporting substrate 210, the second substrate-side light-shielding film 20BM was formed to extend along the outer frame of the display screen and in the extension direction (first direction 11D) of the gate lines between the sub-pixels 10P, so that the second substrate 200 was produced. Furthermore, the second alignment film 420 was formed on the second substrate-side light-shielding film 20BM. The alignment treatment was performed on the second alignment film 420 such that in a plan view, the alignment direction of the liquid crystal molecules 300L located near the second alignment film 420 (second substrate 200) and within the central portions of the openings 100E2X with no voltage applied would be in the direction 11DV vertical to the first direction 11D. Here, the second alignment films 420 in Examples 1 to 4 were the alignment films A to D, respectively.

The first substrate 100 including the first alignment film 410 and the second substrate 200 including the second alignment film 420 were opposed to each other such that their alignment films would face each other. The liquid crystal layer 300 containing the liquid crystal molecules 300L having a positive anisotropy of dielectric constant was interposed between the alignment films, whereby the substrates were attached to each other.

Moreover, the first polarizing plate 510 was arranged adjacent to the surface of the first substrate 100 opposite to the liquid crystal layer 300, and the second polarizing plate 520 was arranged adjacent to the surface of the second substrate 200 opposite to the liquid crystal layer 300, so that the liquid crystal panel was obtained. The polarization axis of the first polarizing plate 510 was parallel to the first direction 11D, and the polarization axis of the first polarizing plate 510 was perpendicular to the polarization axis of the second polarizing plate 520.

The liquid crystal panel was then connected to the drivers (source driver and gate driver) and driving circuits, followed by arrangement of a backlight. Thereby, a liquid crystal display device was produced.

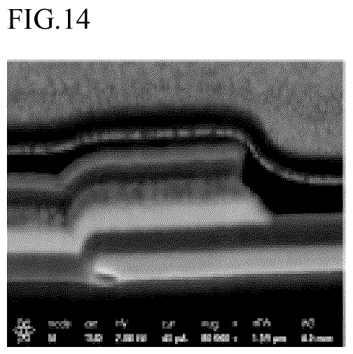

In observation of the liquid crystal display devices of Examples 1 to 4 using a SEM, step portions as shown in FIG. 14 were observed. FIG. 14 is an example scanning electron micrograph of the liquid crystal display devices according to Examples 1 to 4.

### Examples 5 to 8

Liquid crystal display devices 1 of Examples 5 to 8 which correspond to the liquid crystal display device 1 of Embodiment 2 were produced. The liquid crystal display devices 1 of Examples 5 to 8 were produced as in Examples 1 to 4, respectively, except that the anisotropy of dielectric constant of the liquid crystal molecules 300L and the alignment treatment directions for the first alignment film 410 and the second alignment film 420 were different.

The liquid crystal molecules 300L in the liquid crystal display devices 1 of Examples 5 to 8 had a negative anisotropy of dielectric constant.

In Examples 5 to 8, the alignment treatment was performed on the first alignment film 410 such that the alignment direction 301A in a plan view of the liquid crystal molecules 300L located near the first alignment film 410 (first substrate 100) and within the central portions of the openings 100E2X with no voltage applied would be parallel to the transverse direction of the panel outer shape (specifically, parallel to the first direction 11D). In other words, the angle formed between the first direction 11D and the alignment direction 301A was 0°. In the liquid crystal display devices 1 of Examples 5 to 8, the alignment direction 301A was parallel to the first direction 11D, and the angle α was 75°.

In Examples 5 to 8, the alignment treatment was performed on the second alignment film 420 such that in a plan view, the alignment direction of the liquid crystal molecules 300L located near the second alignment film 420 (second substrate 200) and within the central portions of the openings 100E2X with no voltage applied would be parallel to the first direction 11D.

### Comparative Example 1

A liquid crystal display device of Comparative Example 1 was produced. The liquid crystal display device of Comparative Example 1 had the same configuration as the liquid crystal display device of Example 1, except that the first alignment film and the second alignment film were each an alignment film E. The alignment film E was a vertical polyimide rubbing alignment film. The alignment film E underwent rubbing treatment with a rubbing cloth such that the alignment direction 301A would be the same as in Examples 1 to 4. The vertical polyimide rubbing alignment film is an alignment film that contains a polymer with a polyimide structure in its main chain and vertically aligns liquid crystal molecules without alignment treatment.

### Comparative Example 2

A liquid crystal display device of Comparative Example 2 was produced under the conditions shown in the following Table 2, which were changed from the conditions in Example 7.

### Results of Examples 1 to 8 and Comparative Examples 1 and 2

The liquid crystal display devices of Examples 1 to 8 and Comparative Examples 1 and 2 were measured for contrast ratio and examined for occurrence of light leakage. The contrast ratio was determined by dividing the luminance during white display of the liquid crystal display device by the luminance during black display. The light leakage was examined by observing the liquid crystal display device during black display under an optical microscope. The results are shown in the following Table 1 and Table 2.

TABLE 1

| | | Anisotropy of | | | | | | | |
|---|---|---|---|---|---|---|---|---|---|
| | | dielectric | | | | Result of | Pre- | | |
| | | constant of | Contact | | | Equation | tilt | | |
| | First alignment film | liquid crystal | angle | | | (1) | angle | | Contrast |
| | Second alignment film | molecules | θa (°) | α (°) | β (°) | (parameter P) | (°) | Light leakage | ratio |
| Example 1 | Alignment film A | Positive | 7 | 3 | 60 | 0.074 | <1 | Not occuured | 600 |
| | (horizontal polyimide | Positive | | 15 | 60 | 0.101 | <1 | Not occuured | 590 |
| | photoalignment film) | Positive | | 45 | 60 | 0.134 | <1 | Not occuured | 550 |
| | | Positive | | 15 | 75 | 0.113 | <1 | Not occuured | 585 |
| | | Positive | | 15 | 90 | 0.117 | <1 | Not occuured | 565 |
| Example 2 | Alignment film B | Positive | 15 | 3 | 60 | 0.159 | <1 | Not occuured | 550 |
| | (horizontal polyimide | Positive | | 15 | 60 | 0.217 | <1 | Not occuured | 530 |
| | photoalignment film) | Positive | | 45 | 60 | 0.289 | <1 | Not occuured | 500 |
| | | Positive | | 15 | 75 | 0.241 | <1 | Not occuured | 525 |
| | | Positive | | 15 | 90 | 0.250 | <1 | Not occuured | 510 |
| Example 3 | Alignment film C | Positive | 40 | 3 | 60 | 0.425 | 3 | Not occuured | 400 |
| | (horizontal polyimide rubbing | Positive | | 15 | 60 | 0.577 | 3 | Not occuured | 380 |
| | alignment film) | Positive | | 45 | 60 | 0.770 | 3 | Not occuured | 360 |
| | | Positive | | 15 | 75 | 0.644 | 3 | Not occuured | 375 |
| | | Positive | | 15 | 90 | 0.667 | 3 | Not occuured | 360 |
| Example 4 | Alignment film D | Positive | 1 | 3 | 60 | 0.010 | <1 | Occuured | 200 |
| | (horizontal polysiloxane | Positive | | 15 | 60 | 0.014 | <1 | Occuured | 140 |
| | photoalignment film) | Positive | | 45 | 60 | 0.019 | <1 | Occuured | 120 |
| | | Positive | | 15 | 75 | 0.016 | <1 | Occuured | 115 |
| Comparative | Alignment film E | Positive | 90 | 3 | 60 | 0.957 | 82 | Not occuured | 10 |
| Example 1 | (vertical polyimide rubbing | Positive | | 15 | 60 | 1.30 | 82 | Not occuured | 10 |
| | alignment film) | Positive | | 45 | 60 | 1.73 | 82 | Not occuured | 10 |

TABLE 2

| | | Anisotropy of | | | | | | | |
|---|---|---|---|---|---|---|---|---|---|
| | | dielectric | | | | Result of | Pre- | | |
| | | constant of | Contact | | | Equation | tilt | | |
| | First alignment film | liquid crystal | angle | | | (1) | angle | | Contrast |
| | Second alignment film | molecules | θa (°) | α (°) | β (°) | (parameter P) | (°) | Light leakage | ratio |
| Example 5 | Alignment film A | Negative | 7 | 45 | 60 | 0.134 | <1 | Not occuured | 570 |
| | (horizontal polyimide | Negative | | 60 | 60 | 0.126 | <1 | Not occuured | 600 |
| | photoalignment film) | Negative | | 87 | 60 | 0.074 | <1 | Not occuured | 620 |
| | | Negative | | 60 | 75 | 0.140 | <1 | Not occuured | 590 |
| | | Negative | | 60 | 90 | 0.145 | <1 | Not occuured | 575 |
| Example 6 | Alignment film B | Negative | 15 | 45 | 60 | 0.289 | <1 | Not occuured | 510 |
| | (horizontal polyimide | Negative | | 60 | 60 | 0.269 | <1 | Not occuured | 535 |
| | photoalignment film) | Negative | | 87 | 60 | 0.159 | <1 | Not occuured | 560 |
| | | Negative | | 60 | 75 | 0.300 | <1 | Not occuured | 530 |
| | | Negative | | 60 | 90 | 0.311 | <1 | Not occuured | 510 |
| Example 7 | Alignment film C | Negative | 40 | 45 | 60 | 0.770 | 3 | Not occuured | 360 |
| | (horizontal polyimide | Negative | | 60 | 60 | 0.718 | 3 | Not occuured | 370 |
| | rubbing alignment film) | Negative | | 87 | 60 | 0.452 | 3 | Not occuured | 400 |
| Example 8 | Alignment film D | Negative | 1 | 45 | 60 | 0.019 | <1 | Occuured | 110 |
| | (horizontal polysiloxane | Negative | | 60 | 60 | 0.018 | <1 | Occuured | 120 |
| | photoalignment film) | Negative | | 87 | 60 | 0.011 | <1 | Occuured | 120 |
| | | Negative | | 60 | 75 | 0.020 | <1 | Occuured | 110 |
| Comparative | Alignment film C | Negative | 40 | 60 | 90 | 0.829 | 3 | Occuured | 70 |
| Example 2 | (horizontal polyimide | | | | | | | | |
| | rubbing alignment film) | | | | | | | | |

Table 1 shows that in Examples 1 to 4 where the parameter P represented by Equation (1) was 0.77 or less, a contrast ratio of 100 or higher was achieved. In contrast, in Comparative Example 1 where the parameter P represented by Equation (1) exceeded 0.77, the contrast ratio was lower than 100.

Table 2 sows that in Examples 5 to 8 where the parameter P represented by Equation (1) was 0.77 or less, a contrast ratio of 100 or higher was achieved. In contrast, in Comparative Example 2 where the parameter P represented by Equation (1) exceeded 0.77, the contrast ratio was lower than 100.

Also, in Examples 1 to 3 where the parameter P represented by Equation (1) was 0.074 or more, light leakage was prevented. In contrast, in Example 4 where the parameter P was less than 0.074, light leakage occurred.

In Examples 5 to 7 where the parameter P represented by Equation (1) was 0.074 or more, light leakage was prevented. In contrast, in Example 8 where the parameter P was less than 0.074, light leakage occurred.

The alignment film A used for Examples 1 and 5 was a photoalignment film with a pre-tilt angle of less than 1°. The liquid crystal display devices 1 of Examples 1 and 5 exhibited no light leakage and had a contrast ratio of 500 or higher.

The alignment film B used for Examples 2 and 6 was a photoalignment film with a pre-tilt angle of less than 1°. The liquid crystal display devices 1 of Examples 2 and 6 exhibited no light leakage and had a contrast ratio of 500 or higher, as in Examples 1 and 5.

The alignment film C used for Examples 3 and 7 was a rubbing alignment film with a pre-tilt angle of 3°. The liquid crystal display devices 1 of Examples 3 and 7 exhibited no light leakage and had a contrast ratio of 300 or higher. The liquid crystal display devices 1 of Examples 3 and 7 had a greater pre-tilt angle, thus exhibited a lower contrast ratio than in Examples 1 and 5 where the alignment film A was used and in Examples 2 and 6 where the alignment film B was used.

The alignment film D used for Examples 4 and 8 was a photoalignment film with a pre-tilt angle of less than 1°. The liquid crystal display devices 1 of Examples 4 and 8 exhibited light leakage but still achieved a contrast ratio of 100 or higher.

The alignment film E used for Comparative Example 1 was a vertical alignment film with a pre-tilt angle of 800 or more. Thus, the liquid crystal molecules hardly responded in the transverse electric field cell, resulting in a contrast ratio of only about 10. The greater the pre-tilt angle, the lower the surface tension, and the less light leakage occurs. However, in the case of the transverse electric field cell, presumably, the contrast ratio was inherently low and thus a sufficient display performance would not be achieved.

The alignment film C was used for Comparative Example 2. However, the parameter P represented by Equation (1) exceeded 0.77, and thus the contrast ratio was lower than 100.

As described above, embodiments of the present disclosure and their modified examples have been described. However, the present disclosure is not limited to these embodiments and their modified examples, and can be implemented in various forms and variations without departing from the spirit or scope of the disclosure. Furthermore, the multiple components disclosed in the above embodiments and their modified examples may be modified as appropriate. For example, certain components from one embodiment or its modified example may be added to another embodiment or its modified example, or some components of one embodiment or its modified example may be omitted.

The drawings schematically illustrate each component primarily to facilitate understanding of the disclosure. Therefore, the thickness, length, quantity, spacing, and other dimensions of the illustrated components may differ from actual values due to the nature of the drawing process. Furthermore, the configurations of the components shown in the above embodiment are merely examples and are not limited. Various modifications can be made without substantially departing from the effect of the present disclosure.

What is claimed is:

1. A liquid crystal display device comprising, in order:
a first substrate including gate lines, source lines, nonlinear elements arranged corresponding to intersections of the gate lines and the source lines, a first electrode, and a second electrode;
a first alignment film;
a liquid crystal layer containing liquid crystal molecules; and
a second substrate,
the gate lines extending in a first direction,
the source lines extending in a second direction which intersects the first direction,
the first electrode and the second electrode at least partially facing each other across an insulating layer,
one electrode of the first electrode and the second electrode being connected to a source line corresponding to the one electrode via a nonlinear element corresponding to the one electrode among the nonlinear elements,
the second electrode being provided with an elongated opening,
the first substrate including a step portion extending in a third direction on a surface closer to the first alignment film,
an angle α, defined in a plan view as an angle between the third direction and an alignment direction of liquid crystal molecules located near the first alignment film and within a central portion of the opening with no voltage applied, being greater than 0° and less than 90°,
a parameter P being 0.77 or less, as calculated based on the angle α, a taper angle β of the step portion, and a contact angle θa of the first alignment film with respect to pure water, in accordance with the following Equation (1):
$$P = ( {θ}_{a} / 90 ° ) \times \{ 1 + 2 sin ( α ) \times cos ( α ) \} \times sin ( β ) \qquad ( 1 )$$
wherein when the taper angle β exceeds 90°, β in Equation (1) is set to 90°.

2. The liquid crystal display device according to claim 1,
wherein the parameter P represented by Equation (1) is 0.074 or more.

3. The liquid crystal display device according to claim 1,
wherein among the liquid crystal molecules, liquid crystal molecules located near the first alignment film are at a pre-tilt angle of 0° or greater and 3° or less.

4. The liquid crystal display device according to claim 1,
wherein the taper angle β of the step portion is 60° or greater and 90° or less.

5. The liquid crystal display device according to claim 1,
wherein, in a plan view, the alignment direction of the liquid crystal molecules located near the first alignment film and within the central portion of the opening with no voltage applied is parallel or perpendicular to the first direction.

6. The liquid crystal display device according to claim 1,
wherein the liquid crystal molecules have a positive anisotropy of dielectric constant,
in a plan view, the alignment direction of the liquid crystal molecules located near the first alignment film and within the central portion of the opening with no voltage applied is perpendicular to the first direction, and
the angle α is 3° or greater and 45° or less.

7. The liquid crystal display device according to claim 1,
wherein the liquid crystal molecules have a negative anisotropy of dielectric constant,
in a plan view, the alignment direction of the liquid crystal molecules located near the first alignment film and within the central portion of the opening with no voltage applied is parallel to the first direction, and
the angle α is 45° or greater and 87° or less.

8. The liquid crystal display device according to claim 1,
wherein the step portion includes an end of the opening of the second electrode.

9. The liquid crystal display device according to claim 1,
wherein the first substrate further includes a light-shielding film arranged adjacent to a surface of the second electrode facing the liquid crystal layer, and
the step portion includes an end of the light-shielding film.

10. The liquid crystal display device according to claim 9,
wherein the step portion further includes an end of the opening of the second electrode.

11. The liquid crystal display device according to claim 9,
wherein the light-shielding film is a metal film or a laminate including a metal film and an inorganic insulating film.

12. The liquid crystal display device according to claim 1,
wherein the alignment film is a photoalignment film that has undergone alignment treatment through irradiation with polarized ultraviolet light.

13. The liquid crystal display device according to claim 1,
wherein the step portion has a height greater than an average film thickness of the first alignment film.

14. The liquid crystal display device according to claim 1,
wherein the first substrate further includes a color filter layer.

15. The liquid crystal display device according to claim 1, further comprising:
a first polarizing plate arranged adjacent to a surface of the first substrate opposite to the liquid crystal layer, the first polarizing plate having a first polarization axis which is parallel or perpendicular to the first direction; and
a second polarizing plate arranged adjacent to a surface of the second substrate opposite to the liquid crystal layer, the second polarizing plate having a second polarization axis which is perpendicular to the first polarization axis.
